(19) United States
(12) Patent Application Publication
(10) Pub. No.: US 2026/0338634 A1
(43) Pub. Date: Oct. 29, 2026

(54) METHODS TO MEASURE LIGHT LOSS AND EFFICIENCY OF DIFFRACTION GRATINGS ON OPTICAL SUBSTRATES

(71) Applicant: Applied Materials, Inc., Santa Clara, CA (US)

(72) Inventors: Yupeng ZHU, Santa Clara, CA (US); Jinxin FU, Fremont, CA (US); Michelle Meng SHI, Santa Clara, CA (US); Yangyang SUN, San Jose, CA (US); Ravi KOMANDURI, Milpitas, CA (US)

(21) Appl. No.: 19/111,758

(22) PCT Filed: Sep. 15, 2023
(86) PCT No.: PCT/US2023/032945

§ 371 Date: Mar. 13, 2025

Related U.S. Application Data
(60) Provisional application No. 63/416,168, filed on Oct. 14, 2022.

(51) Int. Cl. G01M 11/02

(52) U.S. Cl. CPC G01M 11/0228; G01M 11/0207

(57) ABSTRACT

Measurement systems and methods of optical device metrology as described herein. In an example, a method includes projecting a light beam of a first intensity to a lens coupler disposed on a first surface of an optical device substrate, the lens coupler in-coupling the light beam into the optical device substrate to undergo total internal refraction. The optical device substrate includes a grating having a plurality of grating lines such that light is out-coupled by the grating at a plurality of contact points. A plurality of intensities of the light beam out-coupled by the grating at the plurality of contact points are measured using a receiver and a total optical loss of the optical device substrate and the grating are determined by comparing the plurality of intensities at the contact points and the first intensity of the light beam.

### BACKGROUND

### Field

Embodiments of the present disclosure relate to optical devices. More specifically, embodiments of the present disclosure relate to measurement systems and methods of optical device metrology.

### Description of the Related Art

Optical devices including waveguide combiners, such as augmented reality waveguide combiners, and flat optical devices, such as metasurfaces, are used to assist in overlaying images. Generated light is propagated through the optical device until the light exits the optical device and is overlaid on the ambient environment for a user to see.

Fabricated optical devices can lose light intensity through absorption and scattering as the light is propagated through the optical device. The optical devices are fabricated from optical substrates, and in some instances optical films, e.g., when an optical device is fabricated from an optical film disposed on an optical substrate. Light loss from the optical device grating and the optical substrate can be measured after fabricating the optical device. Single interaction measurement systems, such as spectroscopy systems, do not reliably measure the amount of light lost or grating efficiency as light propagates through or out of the optical device.

Therefore, what is needed in the art is measurement systems and methods of optical device metrology.

### SUMMARY

In an embodiment, a method of optical device metrology is provided. The method includes projecting a light beam of a first intensity to a lens coupler disposed on a first surface of an optical device substrate, the lens coupler in-coupling the light beam into the optical device substrate to undergo total internal refraction. The optical device substrate includes a grating having a plurality of grating lines such that light is out-coupled by the grating at a plurality of contact points. A plurality of intensities of the light beam out-coupled by the grating at the plurality of contact points are measured using a receiver and a total optical loss of the optical device substrate and the grating are determined by comparing the plurality of intensities at the contact points and the first intensity of the light beam.

In another embodiment, a method of optical device metrology is provided. The method includes projecting a light beam at a first power into a input grating coupler located on a first portion of an optical device substrate, the input grating coupler in-coupling the light beam into the optical device substrate to undergo total internal refraction. The light beam is out-coupled in a second portion of the optical device substrate with a lens coupler and capturing the light beam with a receiver. The receiver records a second power, and an efficiency of the input grating coupler is determined by comparing the first power and the second power.

In another embodiment, a method of optical device metrology is provided. The method includes projecting a light beam at a first power into a lens coupler located on a first portion of an optical device substrate, the lens coupler in-coupling the light beam into the optical device substrate to undergo total internal refraction. The light beam is out-coupled using an output grating coupler and capturing the light beam with a receiver. The receiver records a second power, and an efficiency of the output grating coupler is determined by comparing the second power and the first power.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1A is a schematic, cross-sectional view of a measurement system according to embodiments disclosed herein.

FIG. 1B is a schematic, top view of the measurement system according to embodiments disclosed herein.

FIG. 2A is a schematic, cross-sectional view of a measurement system according to embodiments disclosed herein.

FIG. 2B is a schematic cross-sectional view of a measurement system according to embodiments disclosed herein.

FIG. 2C is a schematic cross-sectional view of a lens of a measurement system according to embodiments disclosed herein.

FIG. 2D is a schematic cross-sectional view of a lens of a measurement system according to embodiments disclosed herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to optical devices. More specifically, embodiments of the present disclosure relate to measurement systems and methods of optical device metrology. Measurement systems described include a measurement system to measure the light loss on a diffraction grating. A different measurement system measures the grating efficiency of an input grating coupler and an output grating coupler.

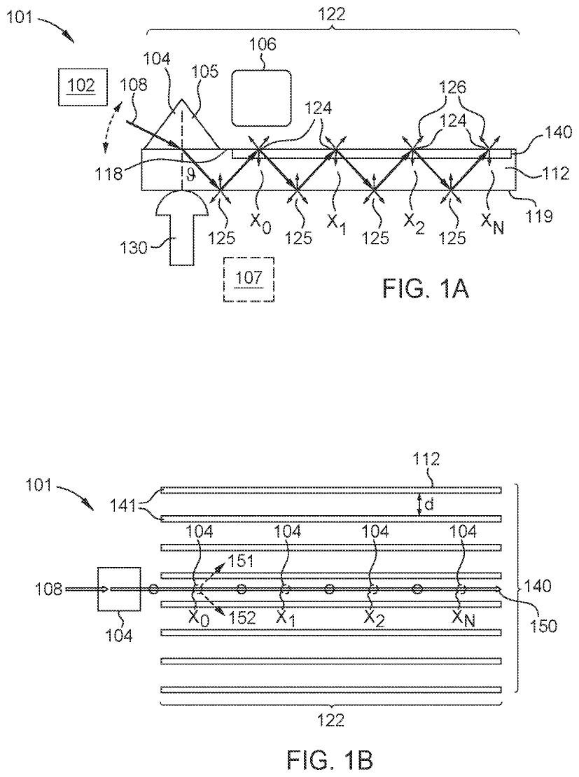

FIG. 1A is a schematic, cross-sectional view of a measurement system 101. FIG. 1B is a schematic, top-view of the measurement system 101. The measurement system 101 includes a light source 102, a lens coupler 104, and a receiver 106. The measurement system 101 is operable to determine a total light loss of light output from a diffraction grating 140. The diffraction grating 140 is disposed in or on a first surface 118 of an optical device substrate 112. A light beam 108 is in-coupled via the light source 102 and the lens coupler 104 and travels through the optical device substrate 112 via total internal reflection (TIR). The light beam 108 is output by the diffraction grating 140. The diffraction grating 140 includes a plurality of grating lines 141 having a pitch d.

The light source 102 is configured to generate and direct the light beam 108 to the lens coupler 104 that is to be incident on the optical device substrate 112. The optical device substrate 112 can be held in position by a stage (not shown) or by fasteners (not shown). The light source 102 can be a laser source, an LED display, or another light source. The light beam 108 (also referred to as a first type of light) is a single wavelength laser with a narrow bandwidth (e.g., <1 pm). In other examples, the light source 102 can be configured to emit a variety of wavelengths, such as a light source that includes two or more lasers. For example, in some embodiments, the light source 102 can be configured to emit ultraviolet light, visible light, infrared light, and/or near infrared light as well as radiation of other wavelengths.

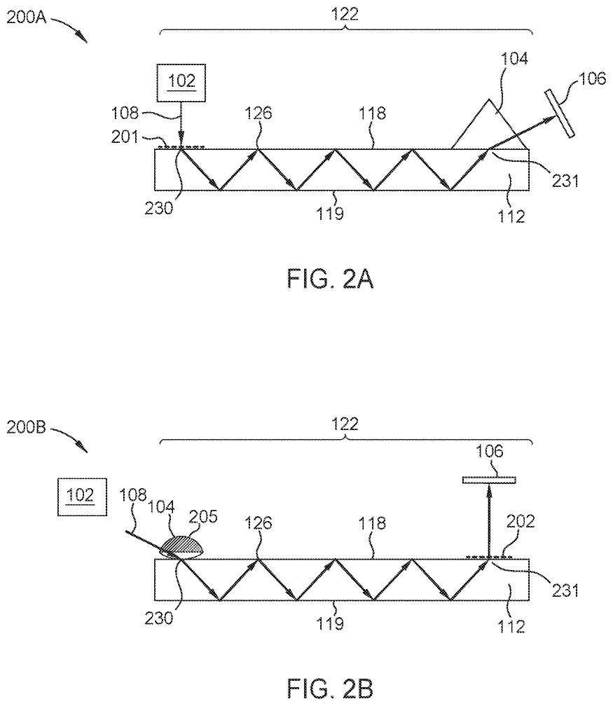

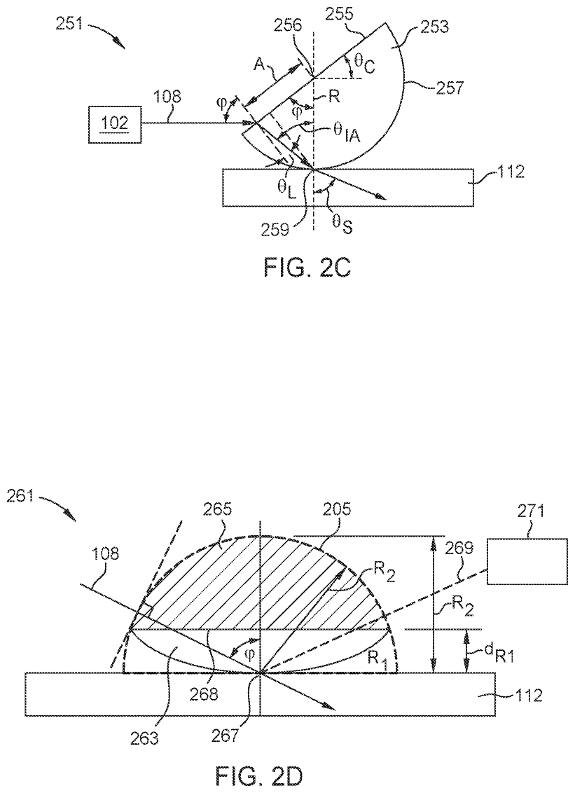

The light beam 108 is in-coupled into the optical device substrate 112 through the lens coupler 104. In one embodiment, the lens coupler 104 is a prism 105 as shown in FIG. 1A. The prism 105 is held to the optical device substrate 112 using a coupling head 130, or other mechanism. In another embodiment, the lens coupler 104 is a bi-convex lens 205. The bi-convex lens 205 has two radii of curvatures which allows multiple incident angles of the light beam 108 to be in-coupled to the optical device substrate 112. The bi-convex lens 205 is described in FIGS. 2B and 2D. The lens coupler 104 ensures the light beam 108 is coupled into the optical device substrate 112. The lens coupler 104 can have a refractive index between about 1.3 and about 3.3. Although the angle of the light beam 108 is not shown to change at all through the lens coupler 104 or the optical device substrate 112, this was done for ease of illustration and the angle may change due to varying refractive indexes of the different materials through which the light beam 108 passes.

The light beam 108 is incident on the optical device substrate 112 between the grating lines 141 at a total internal reflection (TIR) angle θ with respect to a first surface 118 or a second surface 119 of the optical device substrate 112. The TIR angle θ is generally between about 15° and about 85°, but angles closer to parallel or perpendicular to the surface (e.g., first surface 118) may also be used. The light beam 108 undergoes TIR between the grating lines 141 along a length 122, which can be part or all of the length of the optical device substrate 112. In some embodiments, which may be combined with other embodiments, an anti-reflective coating is disposed on the second surface 119 of the optical device substrate 112. The anti-reflective coating will limit non-TIR reflection of light on the second surface 119.

The light beam 108 can propagate through the optical device substrate 112 and can be incident upon a plurality of contact points 124 located at or near the surface from which the measurements of intensity are detected (e.g., first surface 118 in FIG. 1A). The plurality of contact points 124 each have a location X₀, X₁, X₂ . . . X_{N} (also referred to as a plurality of locations) along the grating lines 141, where N is a total number of the plurality of contact points 124 from which the measurements are taken. Decreasing the TIR angle θ can increase the number of the locations X₀, X₁ . . . X_{N} leading to more data points for analysis while increasing the TIR angle θ can decrease the number of the locations X₀, X₁ . . . X_{N} leading to less data points that are further spread apart and thus can be more easily analyzed (i.e., the data is less noisy) for determining the optical loss portions of the optical device substrate 112 and the diffraction grating 140.

As shown in FIG. 1B, the light beam 108 enters the lens coupler 104, the lens coupler 104 in-coupling the light beam 108 into the optical device substrate 112 between the grating lines 141. Inside the substrate the light can propagate parallel to the diffraction grating 140 in a direction 150 parallel to the grating lines 141. The light beam 108 does not propagate in a negative first order direction 151 or a positive first order direction 152 if two diffraction conditions are satisfied. First, the light beam 108 is parallel to the grating lines 141 to avoid introducing a beam component perpendicular to the grating lines 141. Second, the TIR angle θ is greater than the diffraction condition. The TIR angle θ is the angle that the light travels though the optical device substrate 112. The TIR angle θ is determined by an angle of the light beam 108 from the lens coupler 104, the refractive index of the lens coupler 104, and the refractive index of the optical device substrate 112 using Snell's law. The equation below describes the relationship.

n₁₀₄ sin θ₁₀₄=n₁₁₂ sin θ

Where n₁₀₄ is the refractive index of the lens coupler 104, θ₁₀₄ is the angle of the light beam 108 from the lens coupler 104, n₁₁₂ is the refractive index of the optical device substrate 112, and θ is the TIR angle. As describe above the TIR angle will be greater than the diffraction condition in order to have TIR as shown in the following inequality.

$$cos θ < \frac{λ}{{n}_{112} d}$$

Where λ is the wavelength of the light beam 108, d is the pitch of the diffraction, and n₁₁₂ is the refractive index of the optical device substrate 112. When the TIR angle, θ, is greater than the diffraction condition both the negative first order direction and positive first order direction are eliminated when the light beam 108 is parallel to the grating lines 141.

The receiver 106 can be a fiber bundle connected to a detector to collect all light that escapes the optical device substrate 112. In some embodiments which can be combined with other embodiments, the fiber bundle can include two or more fiber heads, but a single fiber head can be used. Other optical devices, including a camera positioned above the optical device substrate 112, configured to collect light can also be used for the receiver 106. Although not shown, it is contemplated that a power sensor disposed on a mask with an opening may be used for the receiver 106 to collect the light. The power sensor and mask are disposed on a translation stage to capture light at each location.

When using the fiber bundle as the receiver 106, while the light beam 108 is directed at the optical device substrate 112, the fiber bundle moves along the length of the optical device substrate 112. The fiber bundle and the detector collect scattered light 126 across the optical device substrate 112 with peaks occurring at each location X₀, X₁, X₂ . . . X_{N}. For example, the fiber bundle moves along the length of the optical device substrate 112 to take different measurements of the light beam 108 as the light beam 108 propagates through the optical device substrate 112. The fiber bundle is in communication with the detector. The detector measures an intensity (also referred to as a quantity) of the scattered light 126 collected by the fiber bundle at each location X₀, X₁, X₂ . . . X_{N}. In some embodiments, which may be combined with other embodiments, the detector can include a Gaussian aperture.

In some operations, a plurality of contact points 125, disposed on the second surface 119 corresponding to points the light beam 108 propagates to be incident to the second surface, are measured for light loss. A second receiver 107 may optionally be positioned facing the second surface to capture and measure light loss. The second receiver 107 can be a second detector with a fiber cable, a second camera, or a second power sensor. The second detector, the second camera, or the second power sensor would be used in the same way as the receiver 106 but will be facing the second surface 119 instead of the first surface 118.

The receiver 106 is configured to measure the intensity of the scattered light 126 across the length 122. These intensity measurements can also be modeled by the following equation

log I_{N}=log I₀−(α_{bulk}*X₀+α_{surf})*N

where α_{bulk}*X₀+α_{surf} is the total light loss from both the optical device substrate 112 and the diffraction grating 140 due to absorption and scattering, α_{bulk} is the total light loss caused by the optical device substrate 112, α_{surf} is the total light loss caused by the diffraction grating 140, X is the distance between successive measuring points at which the light encounters the diffraction grating 140 due to TIR (e.g., a distance between X₀ and X₁ in FIG. 1A), I_{N} is the intensity measured at a location X_{N}, I₀ is the intensity measured at the location X₀, and N is the number of times the light has encountered the diffraction grating 140 due to TIR at the location X_{N}. The amount of light loss due to the optical device substrate 112 (α_{bulk}) is related to the distance the light travels through the optical device substrate 112, and surface optical loss caused by the substrate surface is found to be negligible. Thus, α_{bulk} has units of reciprocal distance (e.g., cm⁻¹) that are the reciprocal of the units of X (e.g., cm). Conversely, the amount of light loss caused by diffraction grating 140 (α_{surf}) is primarily due to surface interaction of the light beam 108 with the surface of the diffraction grating 140. Thus, this light loss is controlled by the number of interactions the light beam has with the surface of the optical film (i.e., N in the equation above) at a given location X_{N}.

In operation of the measurement system 101, first, the light source 102 directs the light beam 108 to the optical device substrate 112. The optical device substrate 112 includes a diffraction grating 140 and a lens coupler 104 on top of the optical device substrate 112 on a first surface 118. The light beam 108 is introduced to the lens coupler 104.

At a second operation, the lens coupler 104 in-couples the light beam 108 into the optical device substrate 112. The light beam 108 propagates to be incident upon the plurality of contact points 124 (X₀, X₁, X₂ . . . X_{N}) as described above in reference to FIGS. 1A and 1B. The light beam 108 propagates through the optical device substrate 112 via TIR.

At a third operation, to measure the scattered light 126 a receiver 106 is used. The receiver 106 is a camera that captures all scattered light from the optical device substrate 112 and diffraction grating 140. In other embodiments, a detector and fiber bundle can be used. The fiber bundle moves along the length of the optical device substrate 112 to collect the scattered light 126. The fiber bundle is disposed above the first surface 118 of the optical device substrate 112.

When either the camera or fiber bundle measures the intensity of the scattered light 126, the intensity measurements can then be used to determine the total optical loss for the optical device substrate 112 and diffraction grating 140. Intensity measurements performed without a grating only can be used to determine the total optical loss caused by the optical device substrate 112 (i.e., α_{bulk}) as described above in reference to this equation log I_{N}=log I₀−(α_{bulk}*X)*N. Then, α_{bulk} can be applied to this equation log I_{N}=log I₀−(α_{bulk}*X+α_{surf})*N to determine the total optical loss caused by the grating (i.e., α_{surf}) as described above.

Then, the magnitude between successive peaks and troughs in the intensity decay measurements can be used to determine a relative amount of optical loss due to scattering with high magnitudes between successive peaks and troughs indicating high scattering and a corresponding low magnitude indicating lower amounts of scattering. If high scattering is identified, then changes to the substrate and/or grating can be made, such as reducing the surface roughness or changing the stoichiometry of the grating and/or substrate. Furthermore, the magnitude between successive peaks and troughs for the measurements performed on the optical device substrate 112 only (i.e., grating) can help determine the relative contribution of the scattering caused by the optical device substrate 112 as opposed to the diffraction grating 140.

FIG. 2A is a schematic, cross-sectional view of a measurement system 200A. The measurement system 200A is used to measure the efficiency of an input grating coupler (IGC) 201. The measurement system 200A includes a light source 102, a lens coupler 104, and a receiver 106. The light source 102 is positioned over the IGC 201 at a first portion 230 along the length 122 of the optical device substrate 112. The IGC 201 is positioned on the first surface 118 or a second surface 119 which corresponds to the bottom of the optical device substrate 112. The lens coupler 104 contacts the optical device substrate 112 on a second portion 231 along the length 122 of the optical device substrate 112. The lens coupler 104 can contact the optical device substrate 112 on the first surface 118 or the second surface 119. The light source produces a light beam 108 that the IGC 201 in-couples into the optical device substrate where the light beam 108 undergoes TIR. The in-coupling can be performed as the light beam enters the optical device substrate when the IGC 201 is on the first surface 118 or the in-coupling can be performed after the light beam 108 has passed into the optical device substrate 112 when the IGC 201 is positioned on the second surface 119. The lens coupler 104 out-couples the light beam 108 where the receiver 106 captures and records the output power of the light beam 108. This can be done on the first surface 118 when the IGC 201 is positioned on the first surface 118 or the out-coupling can be performed on the second surface 119 when the IGC 201 is positioned on the second surface 119. The output power of the light beam 108 captured by the receiver 106 and the input power of the light beam 108 is used to determine the efficiency of the IGC 201. This is calculated by the following equation.

$$Efficiency = \frac{{P}_{out} + {P}_{loss}}{{P}_{in}}$$

Where Pₒᵤₜ is the output power captured and recorded by the receiver 106, Pin is the input power of the light beam 108, and Pₗₒₛₛ is determined using optical loss measurements without the diffraction grating 140. Pin is the power of the light beam 108 entering the IGC 201 and (Pₒᵤₜ+Pₗₒₛₛ) is the power of the light beam 108 leaving the IGC 201 making the efficiency equation the efficiency of the IGC 201.

FIG. 2B is a schematic, cross-sectional view of a measurement system 200B. The measurement system 200B includes a light source 102, a lens coupler 104, and a receiver 106. The light source 102 is positioned next to the lens coupler 104 that contacts the optical device substrate 112 at the first portion 230 along the length 122 of the optical device substrate 112. An output grating coupler (OGC) 202 is positioned at the second portion 231 along the length 122 of the optical device substrate 112 on the first surface 118. The light source 102 produces a light beam 108 that travels through the lens coupler 104 that in-couples the light beam 108 into the optical device substrate 112 where the light beam 108 undergoes TIR. The OGC 202 out-couples the light beam 108 where the receiver 106 captures and records the output power of the light beam 108. The light beam can be out-coupled up from the first surface 118 where the receiver 106 is positioned above in some embodiments. In other embodiments, the OGC 202 reflects the light beam 108, out-coupling the light beam through the second surface 119. In these embodiments, the receiver 106 is positioned below the second surface 119 to capture the output power of the light beam 108. The output power of the light beam 108 captured and recorded by the receiver 106 and the input power of the light beam 108 is used to determine the efficiency of the OGC 202. This is calculated by the following the previous equation.

$$Efficiency = \frac{{P}_{out} + {P}_{loss}}{{P}_{in}}$$

Where Pₒᵤₜ is the output power captured and recorded by the receiver 106, Pᵢₙ is the input power of the light beam 108, and Pₗₒₛₛ is determined using optical loss measurements without the diffraction grating 140. Pᵢₙ is the power of the light beam 108 entering the OGC 202 and (Pₒᵤₜ+Pₗₒₛₛ) is the power of the light beam 108 leaving the OGC 202 making the efficiency equation the efficiency of the OGC 202. The lens coupler 104 is a bi-convex lens 205 as in FIG. 2B but a prism 105 can be used in other embodiments as in FIG. 2A. The receiver 106 is a camera or a detector, and may be attached to a fiber bundle.

FIG. 2C is a schematic cross-sectional view of a lens coupling approach 251 for a measurement system including measurement system 101, measurement system 200A, and measurement system 200B. The lens coupling approach 251 includes a hemisphere lens 253. The light beam 108 approaches the hemisphere lens 253 parallel with the optical device substrate 112. The light beam 108 enters the hemisphere lens 253 at an angle φ with a flat face 255 of the hemisphere lens 253. The hemisphere lens 253 is rotated an angle θ_{C} from the flat face 255 being parallel with the first surface 118 of the optical device substrate 112. A curved face 257 of the hemisphere lens 253 is positioned to contact the first surface 118 of the optical device substrate 112 at a contact point 259.

The hemisphere lens 253, light beam 108, and optical device substrate 112 are positioned such that the light beam 108 in the hemisphere lens 253 is incident at the contact point 259 with the optical device substrate 112 at an incident angle θ_{IA} measured from the normal axis of the optical device substrate 112. The incident angle θ_{IA} is described in the following equation.

$${θ}_{IA} = \frac{π}{2} + {sin}^{- 1} ( \frac{sin φ}{{n}_{lens}} ) - φ$$

Where φ is the angle the light beam 108 enters the hemisphere lens 253, in radians, and nₗₑₙₛ is the refractive index of hemisphere lens 253 at the wavelength of the light beam 108. If the following equation is satisfied, the light beam 108 will enter the substrate in TIR.

$${θ}_{IA} > {sin}^{- 1} \frac{1}{{n}_{lens}}$$

Where the variables are the same as described above. The right side of the inequality is also equal to θ_{C}. A lens incident angle θ_{L} exists between the light beam 108 in the hemisphere lens 253 and the normal axis of the hemisphere lens 253. The lens incident angle θ_{L} is defined by the following equation.

$${θ}_{L} = {sin}^{- 1} ( \frac{sin φ}{{n}_{lens}} )$$

The light beam 108 enters the optical device substrate 112 at a substrate angle θₛ. The substrate angle θₛ is defined by the following equation.

$${θ}_{s} = {sin}^{- 1} ( \frac{{n}_{lens} sin {θ}_{IA}}{{n}_{s}} )$$

Where nₛ is the refractive index of the optical device substrate 112 at the wavelength of the light beam 108. A center point 256 on the flat face 255 is a set distance A away from the point of contact of the light beam 108 and the hemisphere lens 253. The distance A is defined by the following equation.

A=R cos φ+R sin φ tan θ_{L}

Where R is the radius of the hemisphere lens 253. The above equations can be used to optimize the angle q and position A the light beam enters the hemisphere lens 253.

Therefore, TIR is possible using the hemisphere lens 253. In the lens coupling approach 251, no coupling head 130 is required to in-couple the light beam 108 into the optical device substrate 112 as the natural contact point 259 of the curved face 257 of the hemisphere lens 253 enables the in-coupling. In the lens coupling approach 251, the positioning of the light beam 108 and the incident angle of the light beam 108 need to be adjusted relative to the hemisphere lens 253 to provide multiple TIR angles within the optical device substrate 112.

FIG. 2D is a schematic cross-sectional view of a lens coupling approach 261 for a measurement system including measurement system 101, measurement system 200A, and measurement system 200B. Lens coupling approach 261 uses the bi-convex lens 205 as shown in FIG. 2B. The bi-convex lens 205 has two different radii of curvatures R₁ and R₂ (e.g., an upper portion and a lower portion). The lower portion has a first face 263. The upper portion has a second face 265. The first face 263 is coupled to the second face 265 at an interface 268. The first face 263 faces the optical device substrate 112. The second face faces away from the optical device substrate 112. As discussed above, this allows multiple incident angles of the light beam 108 to be in-coupled to the optical device substrate 112. A total thickness of the bi-convex lens 205 is equal to the radius of curvature R₂. The first face 263 of the bi-convex lens 205 is uncoated and has the radius of curvature R₁. The second face 265 of the bi-convex lens 205 has the radius of curvature R₂ and is coated in an anti-reflection coating. The anti-reflection coatings may include silicon nitride, silicon dioxide, titanium oxide, magnesium fluoride, similar materials, or any combination thereof, The bi-convex lens 205 contacts the optical device substrate 112 at a contact point 267 on the first face 263. The contact point 267 is located at the center of the first face 263. The contact point 267 also marks the center of a hemisphere with a radius equal to the radius of curvature R₂. The first face 263 has a thickness d_{R1} measured from the contact point 267 to the interface 268 with the second face 265. The thickness d_{R1} determines a range of incident angles φ_{bc} the light beam 108 can enter the bi-convex lens 205. The smaller the thickness d_{R1} the wider the range of incident angles φ_{bc}. The larger the thickness d_{R1} the more narrow the range of incident angles φ_{bc}.

Lens coupling approach 261 is beneficial due to the wide range of the incident coupling angles φ_{bc}, all incident coupling angles are normally incident on the second face 265 with the same contact point 267. Therefore, if the second face 265 is coated with the Anti-Reflection Coating the loss from incident reflection can be eliminated for all incident angles φ_{bc}. Further, due to the symmetrical nature of the bi-convex lens 205, depending on the value of the radius of curvature R₁ and the size of the light beam 108, a portion 269 of the light beam 108 may not be un-coupled from the substrate but instead exits the bi-convex lens 205 with minimal reflection loss as shown in FIG. 2D. This light can be collected by a sensor 271 and used to estimate the light undergoing TIR.

P_{TIR}=P_{LB}−P₂₆₉

Where P_{TIR} is the light undergoing TIR, P_{LB} is the amount of source light from the light beam 108 and P₂₆₉ is the amount of light in the portion 269. The above equation is useful as a baseline for other measurements that can be performed using the measurement systems 101, 200A, and 200B. The sensor 271 can be used with the measurement systems 101, 200A, and 200B shown in FIGS. 1A, 2A, 2B respectively.

For example, P_{LB}-P₂₆₉ can be used to calculate a transmitted diffraction efficiency, ηT, and a transmitted diffraction efficiency, ηR, for the measurement system 101 shown in FIG. 1A. In this example, the second surface 119 of the optical device substrate 112 is covered in the anti-reflective coating, and the receiver 106 is the power sensor. The second receiver 107 is the second power sensor and positioned facing the second surface 119. The sensor 271 is positioned above the bi-convex lens 205. The equation for the transmitted diffraction efficiency is below.

$${η}_{T} = \frac{{P}_{T}}{{P}_{LB} - {P}_{269}}$$

Where Pt is the light power captured by the power sensor. The equation for the reflected diffraction efficiency is below.

$${η}_{R} = \frac{{P}_{R}}{{P}_{LB} - {P}_{269}}$$

Where P_{R} is the light power captured by the second power sensor.

In summation, embodiments of the present disclosure relate to measurement systems and methods of optical device metrology. In an embodiment, a method of optical device metrology is provided. The method includes projecting a light beam of a first intensity to a lens coupler disposed on a first surface of an optical device substrate, the lens coupler in-coupling the light beam into the optical device substrate to undergo total internal refraction. The optical device substrate includes a grating having a plurality of grating lines such that light is out-coupled by the grating at a plurality of contact points. A plurality of intensities of the light beam out-coupled by the grating at the plurality of contact points are measured using a receiver and a total optical loss of the optical device substrate and the grating are determined by comparing the plurality of intensities at the contact points and the first intensity of the light beam. The hemisphere lens and biconvex lens described herein provide benefits to use in measurement systems. Benefits include a reduction in the amount of components required. The lenses described provide flexibility in alignment and mounting of the lens and substrates. The types of measurement that can be performed in TIR within a substrate are increased by using the lenses. The measurement systems described herein provide quantitative analysis of low light loss and the ability to measure the diffraction efficiency from a diffraction grating and the substrate. The measurement systems can be used to calculate efficiencies of the diffraction gratings and substrates even when the light is in TIR. The measurement systems are helpful for both macroscale waveguides for alternative reality devices and virtual reality devices. The measurement systems are also helpful for microscale waveguides like integrated photonics. The measurement systems can be used to measure light loss with detectors of normal sensitivity.

While the foregoing is directed to embodiments of the present disclosure, other and further embodiments of the disclosure may be devised without departing from the basic scope thereof, and the scope thereof is determined by the claims that follow.

What is claimed is:

1. A method of optical device metrology comprising:
projecting a light beam of a first intensity to a lens coupler disposed on a first surface of an optical device substrate, the lens coupler in-coupling the light beam into the optical device substrate to undergo total internal refraction (TIR), the optical device substrate comprises a grating having a plurality of grating lines such that light is out-coupled by the grating at a plurality of contact points;
measuring a plurality of intensities of the light beam out-coupled by the grating at the plurality of contact points using a receiver; and
determining a total optical loss of the optical device substrate and the grating by comparing the plurality of intensities at the contact points and the first intensity of the light beam.

2. The method of claim 1, wherein the total optical loss between contact points is determined using the following equation log I_{N}=log I₀−(α_{bulk}*X₀+α_{surf})*N, wherein the total loss is (α_{bulk}*X₀+α_{surf}), wherein:
Iₒ is the first intensity;
I_{N} is the second intensity;
X₀ is a distance where the light beam hits the grating;
α_{bulk} is a total light loss caused by the optical substrate;
α_{surf} is a total light loss caused by the optical substrate; and
N is the amount of times the light beam contacts the grating.

3. The method of claim 1, wherein the receiver comprises a first receiver measuring the plurality of intensities of the light beam out-coupled by the grating at the plurality of contact points and a second receiver is measuring the plurality of intensities of the light beam out-coupled from the optical device substrate on a second surface of the optical device substrate.

4. The method of claim 1, wherein the lens coupler is a prism disposed on the first surface of the optical device substrate with a coupling head disposed on a second surface of the optical device substrate, the coupling head holding the prism to the optical device substrate.

5. The method of claim 1, wherein the lens coupler is a bi-convex lens with a first face with a first radius of curvature and second face with a second radius of curvature.

6. The method of claim 5, wherein the second face of the bi-convex lens is coated in an anti-reflective coating.

7. The method of claim 6, wherein a power sensor is disposed above the bi-convex lens in a position to capture and measure any portion of light not in-coupled to the optical device substrate.

8. The method of claim 1, wherein the receiver is a camera positioned above the optical device substrate.

9. The method of claim 1, wherein the receiver is a detector attached to a fiber bundle.

10. The method of claim 3, wherein the first receiver is a first power sensor disposed on a first mask with an opening disposed on a first translation stage facing the first surface of the optical device substrate and the second receiver is a second power sensor disposed on a second mask with an opening disposed on a second translation stage facing the second surface of the optical device substrate.

11. The method of claim 1, wherein the lens coupler is a hemisphere lens is in contact with the optical device substrate is positioned at an angle θ_{C} to cause light to be in-coupled in TIR.

12. A method of optical device metrology comprising:
projecting a light beam at a first power into a input grating coupler located on a first portion of an optical device substrate, the input grating coupler in-coupling the light beam into the optical device substrate to undergo total internal refraction (TIR);
out-coupling the light beam in a second portion of the optical device substrate with a lens coupler and capturing the light beam with a receiver;
recording a second power with the receiver; and
determining an efficiency of the input grating coupler by comparing the first power and the second power.

13. The method of claim 12, wherein the lens coupler is a prism.

14. The method of claim 12, wherein the lens coupler is a bi-convex lens with a first face with a first radius of curvature and second face with a second radius of curvature.

15. The method of claim 14, wherein the second face of the bi-convex lens is coated in an anti-reflective coating.

16. A method of optical device metrology comprising:
projecting a light beam at a first power into a lens coupler located on a first portion of an optical device substrate, the lens coupler in-coupling the light beam into the optical device substrate to undergo total internal refraction (TIR);
out-coupling the light beam using a output grating coupler and capturing the light beam with a receiver;
recording a second power with the receiver; and
determining an efficiency of the output grating coupler by comparing the second power and the first power.

17. The method of claim 16, wherein the lens coupler is a prism.

18. The method of claim 16, wherein the lens coupler is a bi-convex lens with a first face with a first radius of curvature and second face with a second radius of curvature.

19. The method of claim 18, wherein the second face of the bi-convex lens is coated in an anti-reflective coating.

20. The method of claim 16, wherein the lens coupler is a hemisphere lens is in contact with the optical device substrate is positioned at an angle θ_{C} to cause light to be in-coupled in TIR.
